(19) United States
(12) Patent Application Publication
(10) Pub. No.: US 2009/0192284 A1
(43) Pub. Date: Jul. 30, 2009

(54) Stabilisers based on polyisocyanates

(75) Inventors: Bernd Bruchmann, Freinsheim (DE); Hauke Malz, Diepholz (DE); Andreas Eipper, Ludwigshafen (DE); Dietrich Scherzer, Neustadt (DE); Simon Schambony, Ludwigshafen (DE); Harald Schäfer, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/586,612

(22) PCT Filed: Jan. 13, 2005
(86) PCT No.: PCT/EP05/00272

§ 371 Date: Jul. 19, 2006

(30) Foreign Application Priority Data
Jan. 21, 2004 (DE) 102004003024.3

(51) Int. Cl. C08G 18/80

(52) U.S. Cl. 528/67

(57) ABSTRACT

Stabilizers composed of
(I) one or more polyisocyanates having an average of from 2 to 10 isocyanate groups per molecule, preferably from 2.1 to 10, particularly preferably from 2.2 to 10,
(II) per mole of isocyanate groups, from 0.1 to 1.0 mol of one or more active ingredient groups which protect plastics from degradation via heat, UV radiation, oxidation, hydrolysis, or mechanical action during processing, where the active ingredient groups have been linked to the polyisocyanates by way of functional groups A which can react with the isocyanate groups, and where the active ingredient groups have been selected from phenols, sterically hindered amines (HALS stabilizers), benzotriazoles, benzophenones, aromatic amines, or phosphites;
(III) per mole of isocyanate groups, from 0 to 0.9 mol of one or more auxiliary groups which modify the properties of the stabilizer, where the auxiliary groups have been linked to the polyisocyanates by way of functional groups B which can react with the isocyanate groups.

The invention relates to stabilizers based on polyisocyanates.

Plastics, e.g. polyolefins, polyamides, polyurethanes, polyacrylates, polycarbonates, polyesters, polyoxymethylenes, polystyrenes, and styrene copolymers are widely used in many fields of everyday life. Examples of these applications are films and fibers, applications in automotive interiors, e.g. cushions and coverings, dashboards or airbags, or exterior automotive applications, such as tires, bumpers, or protective profiles, and also cable sheathing, housings, shoe soles, dispersions, lacquers for coating metal, wood, plastics, paper or leather or paints.

The plastics in these various applications are exposed to a very wide variety of stresses. For example, plastics used in the engine compartment of a motor vehicle have to withstand high temperatures. Plastics films or lacquers exposed to sunlight are subject to the damaging effect of UV light. UV light and thermal stress generally lead to discoloration of the plastics and/or to impairment of the property profile of the plastics. Impairment of the appearance and the mechanical properties of the plastic can finally render the product produced therefrom unusable for the intended purpose.

The differing chemical structure of plastics gives them differing stabilities with respect to degradation due to UV light and thermal stress and degradation resulting from general environmental effects. However, it is desirable to maximize the range of application of all plastics, i.e. to improve the stability of the plastics with respect to environmental effects, such as heat, sunlight and UV light.

Plastics are also often impaired before processing is complete as a result of high processing temperatures and/or high shear forces.

It is known that plastics can be protected from damaging environmental effects by adding stabilizers. By way of example, plastics may be protected from UV-degradation by a mixture of an antioxidant (AO) and a hindered amine light stabilizer (HALS), or by a mixture of a UV absorber and a phenolic antioxidant, or by a mixture of a phenolic antioxidant, a HALS, and a UV absorber. A method which has mostly proven successful for protection from degradation due to thermal stress is the addition of antioxidants, such as sterically hindered phenols, aromatic amines, and phosphites, or thiosynergists.

The number of different stabilizers and stabilizer combinations now commercially available is immense. Plastics Additive Handbook, 5th Edition, H. Zweifel, ed., Hanser Publishers, Munich, 2001, p. 98-136 gives examples of such compounds.

One problem with stabilizers is their migration within the plastic, i.e. their volatility and their tendency toward bloom, bleed-out, or leaching-out. For example, it has been found that stabilizers whose molar mass is too low evaporate from the plastic. This is in particular a problem when the surface area/volume ratio of a plastics molding is very high. The loss of the stabilizer by evaporation, termed “fogging” can cause threshold values for the total amount of volatile constituents to be exceeded in certain applications, e.g. in automotive interiors, leading to rejection of the plastic for that application.

In order to reduce volatility, stabilizers are usually oligomerized, polymerized, or linked to an organic anchor group, in order to increase molar mass. In this context, an organic anchor group is an organic radical whose task is to increase the molar mass of the stabilizer. One or more stabilizers may be linked to such an anchor group. However, the increase in molar mass can cause the compatibility of the stabilizer with the polymer to reduce to the extent that bloom, i.e. formation of deposits of the stabilizer, arises on the surface of the product. These deposits impair the appearance of the product and can therefore lead to complaints. In addition, the bloom lowers the concentration of the stabilizer and therefore the effectiveness of the stabilizer mixture. Bloom is a particularly relevant problem in the case of thick workpieces with a small surface area/volume ratio.

The incompatibility of a stabilizer with a polymer, and therefore the risk of stabilizer bloom, is highly dependent on the stabilizer/polymer combination and is unpredictable. For example, a stabilizer which can be used without difficulty in one polymer can cause very substantial bloom in another polymer. The result is not only that a producer of various plastics has to have access to a large number of different stabilizers with identical active ingredient groups, but also that the tests for finding the ideal stabilizers become very complicated, since the requirements for each polymer also include a fresh study of migration properties of the stabilizers.

In addition, at excessively high molar masses, e.g. on polymerization of the active ingredient group, the mobility of the stabilizer is lowered so that its effectiveness is reduced, because diffusion of the stabilizer can no longer compensate for concentration differences resulting from degradation reactions.

Another problem consists in the leaching-out of a stabilizer through contact of the plastic with a liquid. This causes not only a reduction in the stabilizer content within the plastic but also contamination of the liquid with the stabilizer. This problem arises particularly in the case of applications in the food and drink sector.

On the other hand, in the case of applications in dispersions or lacquers it can be necessary for the stabilizer to become emulsified or dissolved in a liquid in order to ensure uniform distribution.

DE-A 101 20 838 discloses polymeric or oligomeric stabilizers based on diols- or polyols, where the components acting as stabilizer are linked to the di- or polyols by way of ester linkages. A disadvantage with these oligomeric or polymeric stabilizers is the lack of resistance of the ester bonds, which can be cleaved under hydrolysis conditions.

There are also known systems which comprise monomeric stabilizers incorporated within a crosslinked polymer. For example, EP-A 0 615 991, EP-A 0 615 992, DE-A 197 30 666, and DE-A 198 04 980 describe heat-curable polyurethane lacquer systems in which the stabilizing component is incorporated into the polymer matrix. According to DE-A 197 30 666 and DE-A 198 04 980, this involves some reaction between polyisocyanates containing uretdione groups and a monomeric stabilizer, the residual NCO groups serving for incorporation of the stabilizer into the polyurethane network.

U.S. Pat. No. 3,627,735 describes the production of fiber products, where a stabilizer composed of a 1:1 adduct composed of diphenylmethane 4,4′-diisocyanate and p-aminophenol is incorporated into the linear fiber polymer by way of side chains.

WO 99/67227 discloses triazine carbamates as UV absorbers, which can be coupled to di- or polyisocyanates. However, the products here are systems with high melting point which are difficult to process or incorporate into a polymer matrix.

It is an object of the present invention to provide stabilizers which are effective against various degradation mechanisms and which have advantageous properties. The stabilizers are intended to be effective against UV radiation, heat, hydrolysis, oxidation or ozone degradation, and to have one or more of the advantageous properties below, these being
low volatility,
no tendency toward bloom or bleed-out,
no leaching-out of the stabilizer from the polymer,
easy to mix and incorporate,
high active ingredient group concentration, based on the total weight of the stabilizer,
capability for application-specific emulsification or dissolution in a liquid component,
capability for easy synthesis by an identical or similar process.

We have found that this object is achieved by way of stabilizers composed of
(I) one or more polyisocyanates having an average of from 2 to 10 isocyanate groups per molecule,
(II) per mole of isocyanate groups, from 0.1 to 1.0 mol of one or more active ingredient groups which protect plastics from degradation via heat, UV radiation, oxidation, hydrolysis, or mechanical action during processing, where the active ingredient groups have been linked to the polyisocyanates by way of functional groups A which can react with the isocyanate groups, and where the active ingredient groups have been selected from steric phenols, sterically hindered amines (HALS stabilizers), benzotriazoles, benzophenones, aromatic amines, or phosphites;
(III) per mole of isocyanate groups, from 0 to 0.9 mol of one or more auxiliary groups which modify the properties of the stabilizer, where the auxiliary groups have been linked to the polyisocyanates by way of functional groups B which can react with the isocyanate groups.

The inventive stabilizers may contain precisely one bonded active ingredient group or more than one bonded active ingredient group, for example two or more different sterically hindered phenols, or one sterically hindered phenol and one HALS compound. The two or more different active ingredient groups may have been selected from different classes of active ingredient (sterically hindered phenols, sterically hindered amines (HALS stabilizers), benzotriazoles, benzophenones, aromatic amines, and phosphites).

Examples of properties of the stabilizers which are modified by way of the auxiliary groups are emulsifiability or solubility in polar or nonpolar solvents, and/or capability for incorporation into a plastic or into a plastics mixture.

The invention further relates to the use of the stabilizers for stabilizing dispersions, lacquers, coatings, dyes, adhesives, food or drink, pharmaceutical products, or cosmetics.

Examples for lacquers are lacquers for coating metal, wood, plastics, paper and leather. Lacquers for coating metal are e.g. automobile lacquers, automobile repair lacquers, coil coatings, can coatings, aircraft lacquers and industrial lacquers.

### Polyisocyanates

The polyisocyanates (I) contain an average of from 2 to 10 isocyanate groups per molecule, preferably from 2.2-8.

Di- and polyisocyanates which may be used are the prior-art aliphatic, cycloaliphatic, and aromatic isocyanates. Preferred di- or polyisocyanates are diphenylmethane 4,4′-diisocyanate, diphenylmethane 2,4′-diisocyanate, the mixtures composed of monomeric diphenylmethane diisocyanates and of oligomeric diphenylmethane diisocyanates (polymeric MDI), tolylene 2,4-diisocyanate, tolylene 2,6-diisocyanate, naphthylene 1,5- and 2,6-diisocyanate, phenylene 1,3- and 1,4-diisocyanate, diphenyl diisocyanate, toluidine diisocyanate, triisocyanatotoluene, tetramethylene diisocyanate, hexamethylene diisocyanate, isophorone diisocyanate, methylenebis(cyclohexyl) 2,4′- or 4,4′-diisocyanate, o-, m-, or p-xylylene diisocyanate, tetramethylxylylene diisocyanate, dodecyl diisocyanate, lysine alkyl ester diisocyanate, where alkyl is C₁-C₁₀-alkyl, 2,2,4- or 2,4,4-trimethylhexamethylene 1,6-diisocyanate, 1,4-diisocyanatocyclohexane, 4-isocyanatomethyloctamethylene 1,8-diisocyanate, 2-butyl-2-ethylpentamethylene diisocyanate, 2-isocyanatopropylcyclohexyl isocyanate, 3(4)-isocyanatomethyl-1-methylcyclohexyl isocyanate, 1,3- or 1,4-bis(isocyanatomethyl)cyclohexane, 1,4-diisocyanato-4-methylpentane, and 4-methylcyclohexane 1,3-diisocyanate (H-TDI).

It is preferable to use mixtures composed of two or more of the abovementioned polyisocyanates.

Other suitable polyisocyanates are compounds which can be prepared from the abovementioned di- or polyisocyanates or their mixtures via linking by means of urethane, allophanate, urea, biuret, uretdione, amide, isocyanurate, carbodiimide, uretonimine, oxadiazinetrione, or iminooxadiazinedione structures. By way of example, the linking mechanisms are described in Becker and Braun, Kunststoff-Handbuch Nr. 7 [Plastics Handbook No. 7], Polyurethane [Polyurethanes], Carl-Hanser-Verlag Munich 1993. It is preferable to use polyisocyanates which contain urethane structures, allophanate structures, urea structures, biuret structures, isocyanurate structures, uretonimine structures, oxadiazinetrione structures, or iminoxadiazinedione structures. It is also possible to use a mixture of the abovementioned polyisocyanates.

The linkage of the di- or polyisocyanates by way of urethane groups preferably takes place with use of alcohols or alcohol mixtures whose functionality is 2 or greater. By way of example, mention may be made of the reaction of 3 mol of hexamethylene diisocyanate, isophorone diisocyanate, tolylene diisocyanate, or diphenylmethylene diisocyanate with ≦δ 1 mol of triol, such as glycerol or trimethylolpropane, or else the reaction of two mol of an oligomeric diphenylmethane diisocyanate (polymeric MDI) with ≦1 mol of diol, such as ethylene glycol, butanediol, hexanediol, or with a polyoxyalkylenediol. These reactions form branched polyisocyanates whose funtionality is greater than 2. In this connection see also Becker and Braun, Kunststoff-Handbuch Nr. 7 [Plastics Handbook No. 7], Polyurethane [Polyurethanes], Carl-Hanser-Verlag Munich 1993, page 91.

Polyisocyanates containing allophanate groups are produced from polyisocyanates containing urethane groups by reacting the urethane groups with further isocyanate groups. In this connection, see also Becker and Braun, Kunststoff-Handbuch Nr. 7 [Plastics Handbook No. 7], Polyurethane [Polyurethanes], Carl-Hanser-Verlag Munich 1993, page 94. Another preparation route is the reaction of oxadiazinetriones with alcohols according to EP 825211. By way of example for the preparation of an allophanate, mention may be made of the reaction of hexamethylene diisocyanate or isophorone diisocyanate with monoalcohols, which according to GB 994 890, EP 496 208, EP 524 500, or EP 524 501 give oligoisocyanates whose functionality is greater than 2. Mention may also be made of the reaction of hexamethylene diisocyanate or isophorone diisocyanate with di- or polyhydric alcohols, as described by way of example in EP 1122273. These reactions form branched polyisocyanates having functionality greater than 2.

By way of example, polyisocyanates containing urea groups and containing biuret groups may be prepared via reactions of isocyanates with water or with amines. In this connection see also Becker and Braun, Kunststoff-Handbuch Nr. 7 [Plastics Handbook No. 7], Polyurethane [Polyurethanes], Carl-Hanser-Verlag Munich 1993, page 95. By way of example, mention may be made of the reaction of hexamethylene diisocyanate or isophorone diisocyanate with water or with water-generating substances, as are described in DE-A 28 08 801, DE-A 34 03 277, or DE-A 15 43 178. These reactions form branched polyisocyanates having functionality greater than 2.

Polyisocyanates containing isocyanurate structures are obtained by catalytic or thermal cyclization of three isocyanate groups. If di- or polyisocyanates are used as starting compounds, the products are generally not only the actual trimers but also higher oligomeric polyisocyanates. The overall functionality of these polyisocyanates is therefore greater than 3. In this connection see also Becker and Braun, Kunststoff-Handbuch Nr. 7 [Plastics Handbook No. 7], Polyurethane [Polyurethanes], Carl-Hanser-Verlag Munich 1993, page 91. By way of example, mention may be made of the preparation of branched polyisocyanates via isocyanuratization of hexamethylene diisocyanate or of isophorone diisocyanate, a possible method for which is that according to DE-A 29 16 201 or DE-A 38 10 908.

Polyisocyanates containing uretonimine groups are obtained via further reaction of isocyanate groups with polyisocyanates containing carbodiimide groups. In this connection see also Becker and Braun, Kunststoff-Handbuch Nr. 7 [Plastics Handbook No. 7], Polyurethane [Polyurethanes], Carl-Hanser-Verlag Munich 1993, page 94.

Polyisocyanates containing oxadiazinetrione groups are obtained via reaction of di- or polyisocyanates with carbon dioxide, e.g. as described in DE-A 16 70 666.

Polyisocyanates containing iminooxadiazinedione groups can be regarded as asymmetric relatives of the polyisocyanates containing isocyanurate groups. The preparation of these compounds is described by way of example in DE-A 197 34 048.

In one preferred embodiment of the invention, use is made of aliphatic or cycloaliphatic branched di- or polyisocyanates.

### Active Ingredient Groups

The inventive stabilizers contain one or more active ingredient groups (II), these active ingredient groups having been linked to the polyisocyanates by way of functional groups A which are reactive toward the NCO groups of the polyisocyanates.

For the purposes of the present invention, active ingredient groups (II) are groups which protect a plastic or a plastics mixture from damaging environmental effects. Examples are primary and secondary antioxidants, hindered amine light stabilizers, UV absorbers, hydrolysis stabilizers, quenchers, and flame retardants.

In principle, an inventive stabilizer may contain one or more active ingredient groups, which may also be different. The number of the active ingredient groups here is variable, as is the ratio of each of the active ingredient groups to the others, the only restrictions on these factors being the result of the number of NCO groups in the polyisocyanates (I). It is not necessary here that every NCO group in the polyisocyanates (I) has been reacted with an active ingredient group.

If the intention is that an inventive stabilizer act as, by way of example, antioxidant, the active ingredient groups (II) which are coupled to the NCO groups of the polyisocyanates (I) may be those which slow or prevent oxidative degradation of a plastic.

One class of active ingredients which act as antioxidants is that of sterically hindered phenols.

In one embodiment of the invention, the inventive stabilizers contain, as active ingredient group (II), a sterically hindered phenol of the general formula (1)

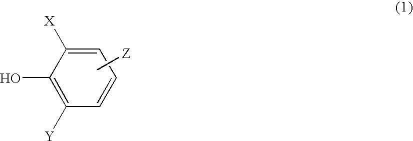

in bonded form.

Here, each of X and Y is, independently of the other, a hydrogen atom or a straight-chain, branched, or cyclic alkyl radical having from 1 to 12 carbon atoms, and Z is a radical of the formula

—C—R′-A
where R¹ is a single bond or a linear or branched divalent organic radical having from 1 to 100 carbon atoms, preferably from 1 to 12 carbon atoms, particularly preferably from 1 to 6 carbon atoms, or R¹ is a divalent radical of the formula

(R²C¹—R³)ₘ—
where each of R² and R³ is identical with or different from the other and, independently of the other, is a single bond, a linear or branched divalent organic radical having from 1 to 50 carbon atoms, preferably from 1 to 10 carbon atoms, in particular from 1 to 4 carbon atoms and m is a number from 1 to 100, preferably from 1 to 10, and particularly preferably from 1 to 4.

Each of C and C′ is, independently of the other, a single bond, an oxygen atom, a sulfur atom, an —NH— or —NR— group, an ester group (—C(O)O— or —O(O)C—), an amide group (—NHC(O)— or —C(O)NH—), a urethane group (—OC(O)NH— or —HNC(O)O—), or a urea group (—HNC(O)N— or —NC(O)NH—).

“Independently of one another” means that R² and, respectively, R³ may be a different radical in each of the m repeat units corresponding to C¹.

A is a functional group which bonds the active ingredient group to the anchor group. Examples of A are primary or secondary amino groups, hydroxy groups, thiol, carboxy groups, or epoxy groups. Preferred functional groups A are hydroxy groups, thiol groups, and primary or secondary amino groups.

The stabilizers preferably contain, as phenolic active ingredient group, a sterically hindered phenol of the formula (1a) in bonded form

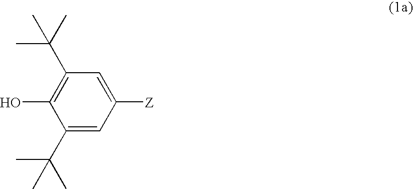

where Z is as defined above.

Another suitable class of active ingredient groups (II) is that of those derived from phosphorus compounds which, by way of example, are used as secondary antioxidant.

In another embodiment of the invention, the inventive stabilizers contain, as active ingredient group (II), a phosphite of the general formula (2)

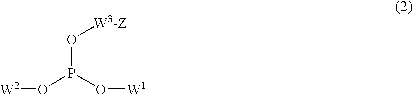

in bonded form. W¹, W², and W³ are, independently of one another, a straight-chain, branched or cyclic alkyl radical having from 1 to 30 carbon atoms, or a substituted or unsubstituted aryl radical having from 3 to 30 carbon atoms. W² and W³ may also, independently of the other, be hydrogen, and Z is as defined above.

An example of a phosphite is the following compound of the formula (2a)

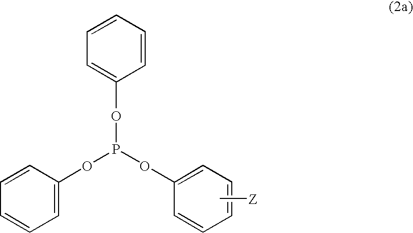

In another embodiment, the inventive stabilizers contain, as active ingredient group (II), benzotriazoles of the general formula (3) in bonded form.

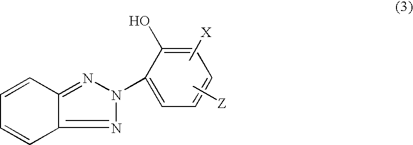

Here, Z is as defined above and X is a straight-chain, branched, or cyclic alkyl radical having from 1 to 12 carbon atoms.

In another embodiment of the invention, the stabilizers contain, as active ingredients, benzophenones of the general formula (4) in bonded form.

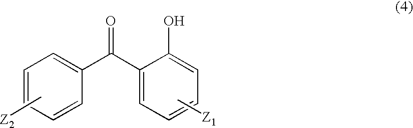

Here, either Z₁ or Z₂ bond to the NCO groups of the isocyanate. Z₁ and Z₂ independently of one another are Z or C—X, where X is a hydrogen atom, a straight-chain or branched alkyl radical, or a cycloalkyl radical having from 1 to 12 carbon atoms, and C and Z are as defined above.

Another group of active ingredients stabilizing polymers with respect to exposure to UV light are those known as hindered amine (light) stabilizers (HAS or HALS). The activity of HALS compounds is based on their ability to form nitroxyl radicals which interfere in the mechanism of oxidation of polymers. HALS are highly efficient UV stabilizers for most polymers.

In another embodiment, the inventive stabilizers comprise, as active ingredient group (II), a sterically hindered amine capable of forming nitroxyl radicals, in bonded form.

In one preferred embodiment of the invention, the inventive stabilizers contain, as active ingredient groups, HALS active ingredients of the formula (5) in bonded form,

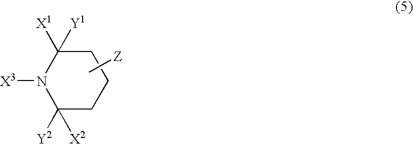

where X¹, X², Y¹, Y², and X³ are, independently of one another, a hydrogen atom, a straight-chain or branched alkyl radical, or a cycloalkyl radical having from 1 to 12 carbon atoms, and X³ may moreover be an acyl radical having from 2 to 18 carbon atoms, an alkoxy radical having from 1 to 19 carbon atoms, or an aryloxycarbonyl radical having from 7 to 12 carbon atoms, and Z is defined as above.

Another group of active ingredients is that of aromatic amines. For the purposes of the present invention, aromatic amines are all of the compounds which have a substituted or unsubstituted amino group directly bonded to an aromatic system. Depending on substitution, aromatic amines serve as antioxidants or else as ingredient active against the damaging effect of ozone.

In another embodiment of the invention, the inventive stabilizers contain, as active ingredient group (II), aromatic amines of the formula (6) in bonded form.

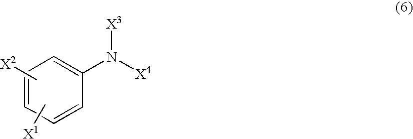

where X¹, X², X³ and X⁴ are, independently of one another, a hydrogen atom, a straight-chain or branched alkyl radical, or a cycloalkyl radical having from 1 to 12 carbon atoms, or Z, where Z is defined as above, and
X⁴ may moreover be

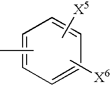

X⁵ and X⁶ are, independently of one another, a hydrogen atom, a straight-chain or branched alkyl radical, or a cycloalkyl radical having from 1 to 12 carbon atoms, or Z, where Z is as defined above.

### Auxiliary Groups

The inventive stabilizers may have one or more auxiliary groups (III).

For the purposes of the present invention, (III) is an auxiliary group which affects the processing, incorporation, emulsifiability, or solubility of the stabilizer as required by the user. By way of example, if the stabilizer is to be dispersed in an aqueous solution, it can be helpful to incorporate an auxiliary group which increases the emulsifiability of the stabilizer. In contrast, for use in hydrocarbon-containing solvents it can be advantageous to increase the level of hydrophobic properties of the product, preferably by incorporating hydrophobic radicals as auxiliary group. Equally, for the processing of the stabilizer it can be important to lower the glass transition temperature and viscosity. Here again, use may then be made of an auxiliary group which inhibits the accumulation of the stabilizer molecules to give aggregates, and thus reduces viscosity. Finally, it is also possible to influence the solubility of the stabilizer as required by the user via the selection of the auxiliary group. By way of example, the result of this can be to reduce migration out of the plastic into food or drink, or to control the distribution of the stabilizer in various polymer blends in favor of one of the two components of the blend. Because a variety of tasks may be allocated to the auxiliary group (III), the nature of the structure of the auxiliary group (III) is highly varied.

Like the active ingredient group (II), the auxiliary group (III) is bonded to the polyisocyanate (I) by way of functional groups B which react with the NCO groups of the polyisocyanate (I). Examples of groups B are primary or secondary amino, hydroxy, thiol, carboxy, or epoxy groups. Preference is given to hydroxy and thiol groups and primary or secondary amino groups.

By way of example, auxiliary groups with hydrophobicizing effect may have the following diagrammatic structure:

B—S

In this context, S is a nonpolar radical, e.g. a straight-chain, branched, or cyclic alkyl radical having from 1 to 10 000 carbon atoms, preferably from 2 to 500 carbon atoms, in particular 4 to 50 carbon atoms.

Examples of S are straight-chain or branched aliphatic structures or aromatic structures, e.g. methyl, ethyl, propyl, butyl, pentyl, hexyl, heptyl, octyl, nonyl, decyl, dodecyl, stearyl, oleyl, palmityl, oligobutyl, oligobutadienyl, oligoisobutyl, polybutyl, polybutadienyl, polyisobutyl, phenyl, naphthyl, or nonylphenyl radicals. Examples of auxiliaries (B—S) with hydrophobicizing effect are stearic acid, oleic acid, palmitic acid, stearoyl chloride, octylamine, stearylamine, polyisobutyleneamine, dipentylamine, diisopentylamine, dihexylamine, octyl alcohol, stearyl alcohol, hexadecanol, octadecanol, octadecenol, polyisobutylene alcohol, nonylphenol, naphthol, benzyl alcohol, or phenylethanol.

If the auxiliary group is intended to have hydrophilicizing effect, (III) may have the following diagrammatic structure:

B-T

In this context, T is a radical with hydrophilicizing effect, e.g. a diethylene glycol monomethyl ether radical, a triethylene glycol monomethyl ether radical, an oligoethylene glycol monomethyl ether radical, a polyethylene glycol monomethyl ether radical, an oligopropylene glycol monomethyl ether radical, a polypropylene glycol monomethyl ether radical, or a poly(ethylene)(propylene) glycol monomethyl ether radical. Other radicals with hydrophilicizing effect are those of aminocarboxylic acids, hydroxycarboxylic acids, mercaptocarboxylic acids, aminosulfonic acids, hydroxysulfonic acids, mercaptosulfonic acids, hydroxyamine compounds, hydroxyammonium compounds, or hydroxyphosphonium compounds.

Examples of auxiliaries with hydrophilicizing effect are diethylene glycol monomethyl ether, triethylene glycol monomethyl ether, oligoethylene glycol monomethyl ether, polyethylene glycol monomethyl ether, oligopropylene glycol monomethyl ether, polypropylene glycol monomethyl ether, poly(ethylene)(propylene) glycol monomethyl ether, 2-methoxyethylamine, di(2-methoxyethyl)amine, 3-(2-methoxyethoxy)propylamine, 9-amino-3,6-dioxanonan-1-ol, or relatively highmolecular-weight polyalkylene oxide amines, well known as Jeffamine® from the company Huntsman, lactic acid, mercaptoacetic acid, hydroxypivalic acid, glycine, Balanine, or taurine, diethanolamine, dipropanolamine, dibutanolamine, N,N-dimethylethanolamine, or N,N-diethylethanolamine.

### Synthesis of the Inventive Stabilizers

The inventive stabilizers are usually prepared by way of a polyaddition reaction, by taking at least one polyisocyanate (I) as anchor group, where appropriate with concomitant use of an organic solvent, under an inert gas, preferably under nitrogen, as initial charge in a reaction vessel, and bringing this to reaction temperature, with stirring. At reaction temperature, at least one active ingredient (II) is then added, continuously or batchwise. The amount of active ingredient (II) depends on the number of NCO groups in the polyisocyanate (I), and is preferably selected in such a way that the ratio of the molar quantity of the isocyanate groups to the molar quantity of the groups A which are reactive toward these and are present in the active ingredient is in essence 1:1. If two or more active ingredients are reacted simultaneously or in succession with the polyisocyanate (I), or if another auxiliary (III) is added to prepare the inventive stabilizer after linking of the active ingredients (II), the total amount of the reactive groups A in the active ingredients (II) and of the reactive groups B in the auxiliaries (III) is adjusted so that it is in essence the same as the total amount of isocyanate groups.

However, the inventive stabilizers may also have up to 20 mol %, preferably up to 10 mol %, of free NCO groups, i.e. NCO groups which have not been consumed by reaction with an active ingredient (II) or with an auxiliary (III).

However, the inventive stabilizers preferably have in essence no free NCO groups.

The reaction time is generally selected in such a way that the NCO groups of the polyisocyanates (I) are reacted completely with the reactive groups A of the active ingredients and, where appropriate, with the reactive groups B of the auxiliaries.

Where appropriate, the abovementioned reaction with the active ingredient groups and with the auxiliaries may take place in the presence of catalysts, the amount used of these being from 0.0001 to 1% by weight, in particular from 0.001 to 0.1% by weight, based in each case on the amount of polyisocyanate (I). Catalysts which may be used for polyaddition reactions are organometallic compounds, especially organotin, or ganozinc, organotitanium, organobismuth, or organozirconium compounds. By way of example, it is particularly preferable to use dibutyltin dilaurate, dibutyltin oxide, titanium tetrabutylate, zinc acetylacetonate, or zirconium acetylacetonate. Use may also be made of strong bases, preferably nitrogen-containing compounds, such as tributylamine, quinuclidine, diazabicyclooctane, diazabicyclononane, diazabicyclononene, diazabicycloundecane, or diazabicycloundecene.

Suitable solvents which may be used are those which are inert toward the starting materials under reaction conditions. By way of example, suitable substances are acetone, 2-butanone, ethyl acetate, butyl acetate, tetrahydrofuran, dioxane, benzene, toluene, xylene, ethylbenzene, chlorobenzene, dichlorobenzene, dimethylformamide, dimethylacetamide, or N-methylpyrrolidone.

The reaction temperature for the polyaddition reaction is usually from −10 to 220° C., preferably from 0 to 180° C. The reaction takes place either at atmospheric pressure or else at a pressure above or below atmospheric pressure, for example at a pressure of from 2 to 20 bar, or at from 0.1 to 0.001 bar.

### EXAMPLES

### Example 1

### Preparation of a Phenolic Active Ingredient

609 g of Pluriol® E 200 (BASF AG), 175 g of Ralox® 35 (methyl 3,5-bis(1,1-dimethylethyl)-4-hydroxybenzylpropionate Raschig GmbH Ludwigshafen), and 2.8 g of Weston® TNPP (General Electric) are added to a 500 ml round-bottomed flask with stirrer, gas-inlet tube, and distillation bridge, under a stream of dry nitrogen. The mixture is heated to 145° C., and 1.8 g of potassium methanolate are added. The resultant methanol is removed by way of the distillation bridge and collected in a cold trap.

After methanol liberation has ended at 145° C. (about 2 h), the reaction mixture is cooled to 80° C. 2.5 g of 85% strength phosphoric acid are then added to neutralize the product. Stirring is continued for a further 15 min at 80° C., and the mixture is then washed with water. For this, 1000 ml of distilled water are heated in a glass beaker to 40° C., and the product, at 80° C., is slowly added to the water, with vigorous stirring. The aqueous mixture is then stirred for 30 min, and allowed to stand until phase separation occurs, and the aqueous phase is then decanted from the product. This washing procedure is repeated. The product is then dried on a rotary evaporator at about 80° C. and 10 mbar.

### Example 2

### Preparation of an Active Ingredient Based on Benzophenone

A mixture composed of 200.0 g (0.93 mol) of 2,4-dihydroxybenzophenone (Aldrich), 90.5 g (1.03 mol) of ethylene carbonate (BASF AG), and 3.5 g (0.01 mol) of tetrabutylammonium iodide is heated to 155° C. and kept at this temperature overnight, with stirring. The mixture is then cooled to 100° C. and treated with 500 ml of water. It is then stirred at 95° C. for 1 h, and then cooled to RT, with rapid stirring. The crude product is filtered off, washed with water, and dried. It is purified by distillation at 0.3 mbar. This gives 206 g (86%) of 2-hydroxy-4-hydroxyethoxybenzophenone with a melting point of 92-94° C.

### Example 3

### Preparation of a Polyisocyanate

135 g of BASONAT HI 100 and 135 g of dry 2-butanone form an initial charge at room temperature, with nitrogen feed, in a reaction vessel with stirrer, gas inlet tube and dropping funnel with pressure equalization, and 300 ppm (based on isocyanate) of dibutyltin dilaurate are added. The mixture is then heated to 50° C., and 6.9 g of 1,4-butanediol dissolved in 6.9 g of dry 2-butanone are added within a period of 1 min, and stirring is continued at 50° C. for 1 h. The solvent is then removed in vacuo on a rotary evaporator.

### Examples 48

### Inventive Stabilizers A-E

The amounts given in table 1 of isocyanate, dissolved in the same weight of dry 2-butanone, form an initial charge in a reaction vessel with stirrer, gas inlet tube, and dropping funnel with pressure equalization, with dry nitrogen feed, and 300 ppm (based on isocyanate) of dibutyltin dilaurate are added at room temperature, and the mixture is heated to 50° C. The amount given in table 1 of 1,2,2,6,6-pentamethylpiperidin-4-ol, dissolved in the same weight of dry 2-butanone, is then added dropwise within a period of 30 min. Once the addition has ended, stirring of the reaction mixture is continued at 50° C. for 1 h. The solvent is then removed in vacuo on a rotary evaporator. The glass transition temperatures (Tg) were determined by differential scanning calorimetry (DSC), and the Tg values for the second heating curve are given. The average molar masses of the stabilizers were determined by gel permeation chromatography (GPC). Dimethylacetamide was used as mobile phase for elution, and the columns were calibrated with polymethyl methacrylate as standard. Further data concerning the stabilizers are given in table 1.

TABLE 1
Polymeric HALS stabilizers

| | Example Nr. | | | | |
|---|---|---|---|---|---|
| | 4 | 5 | 6 | 7 | 8 |
| | Stabilizer A | Stabilizer B | Stabilizer C | Stabilizer D | Stabilizer E |
| Isocyanate (g) | Basonat HI | Basonat HB | Polyisocyanate | Basonat HA | Lupranat M |
| | 100 | 100 | from example 3 | 300 | 20 W |
| | (135.0) | (135.0) | (141.9) | (135.0) | (39.9) |
| 1,2,2,6,6- | 121.2 | 124.5 | 95.1 | 100.8 | 50.0 |
| Pentamethyl- | | | | | |
| piperidin-4-ol (g) | | | | | |
| Glass transition | 33.5 | 34.5 | 45.7 | 11.4 | 87.1 |
| temperature Tg | | | | | |
| (° C.) | | | | | |
| Weight-average | 2480 | 2700 | 6100 | 1930 | 580 |
| molar mass | | | | | |
| Mw (g/mol) | | | | | |
| Number-average | 1960 | 1890 | 2890 | 1370 | 470 |
| molar mass | | | | | |
| Mn (g/mol) | | | | | |

### Examples 9-12

### Inventive Stabilizers F-I

The amounts given in table 2 of sterically hindered phenol from example 1, dissolved in the same weight of dry 2-butanone, form an initial charge in a reaction vessel with stirrer, gas inlet tube, and dropping funnel with pressure equalization, with dry nitrogen feed, and 300 ppm (based on isocyanate) of dibutyltin dilaurate are added at room temperature, and the mixture is heated to 50° C. The amount given in table 2 of isocyanate, dissolved in the same weight of dry 2-butanone, is then added dropwise within a period of 15 min. Once the addition has ended, stirring of the reaction mixture is continued at 50° C. for 1 h. The solvent is then removed in vacuo on a rotary evaporator. The glass transition temperatures (Tg) were determined by differential scanning calorimetry (DSC), and the Tg values for the second heating curve are given. The average molar masses of the stabilizers were determined by gel permeation chromatography (GPC). Dimethylacetamide was used as mobile phase for elution, and the columns were calibrated with polymethyl methacrylate as standard. Further data concerning the stabilizers are given in table 2.

TABLE 2
Polymeric phenolic stabilizers

| | Example Nr. | | | |
|---|---|---|---|---|
| | 9 | 10 | 11 | 12 |
| | Stabilizer F | Stabilizer G | Stabilizer H | Stabilizer I |
| Isocyanate (g) | Basonat HI 100 | Basonat HB 100 | Polyisocyanate | Basonat HA 300 |
| | (15.0) | (15.0) | from example 3 | (18.0) |
| | | | (18.0) | |
| Sterically hindered | 41.0 | 42.1 | 36.7 | 41.0 |
| phenol from example 1 | | | | |
| (g) | | | | |
| Glass transition | 0.9 | 1.9 | 1.2 | −8.3 |
| temperature Tg (° C.) | | | | |
| Weight-average molar | 4830 | 4680 | 9980 | 3560 |
| mass Mw (g/mol) | | | | |
| Number-average molar | 3300 | 3170 | 4420 | 2350 |
| mass Mn (g/mol) | | | | |

### Example 13

### Inventive Stabilizer J—Stabilizer System

18.1 g of sterically hindered phenol from example 1, 11.9 g of 1,2,2,6,6-pentamethylpiperidin-4-ol, 60 g of dry acetone, and 300 ppm (based on isocyanate) of dibutyltin dilaurate are added at room temperature to a reaction vessel with stirrer, gas inlet tube, and dropping funnel with pressure equalization, with dry nitrogen feed, and the mixture is heated to 50° C. 20.0 g of BASONAT HI 100 dissolved in 40 g of dry acetone are then added dropwise within 15 min. Once the addition has ended, stirring of the reaction mixture is continued at 50° C. for 1 h. The solvent is then removed in vacuo on a rotary evaporator. The glass transition temperature Tg of the product is 2.3° C.

### Example 14

### Inventive Stabilizer K—Stabilizer System

6.8 g of sterically hindered phenol from example 1, 4.5 g of 1,2,2,6,6-pentamethylpiperidin-4-ol, 40 g of dry acetone, and 300 ppm (based on isocyanate) of dibutyltin dilaurate are added at room temperature to a reaction vessel with stirrer, gas inlet tube, and dropping funnel with pressure equalization, with dry nitrogen feed, and the mixture is heated to 50° C. 20.0 g of BASONAT HI 100 dissolved in 40 g of dry acetone are then added dropwise within 15 min. Once the addition has ended, stirring of the reaction mixture is continued at 50° C. for 1 h. 16.9 g of benzophenone stabilizer from example 2 dissolved in 34 g of dry acetone are then added dropwise within a period of 15 min, and stirring is again continued at 50° C. for 1 h. The solvent is then removed in vacuo on a rotary evaporator. The glass transition temperature of Tg of the product is −3.9° C.

BASONAT®HI 100 (BASF AG): aliphatic polyisocyanurate based on hexamethylene diisocyanate, average functionality being about 3.7 NCO groups per molecule.

BASONAT®HB 100 (BASF AG): aliphatic polybiuret based on hexamethylene diisocyanate, average functionality being about 3.7 NCO groups per molecule.

BASONAT®HA 300 (BASF AG): aliphatic polyisocyanate based on hexamethylene diisocyanate, average functionality being about 3.7 NCO groups per molecule.

LUPRANA®M 20 W (Elastogran GmbH): aromatic polyisocyanate based on diphenylmethane diisocyanate, average functionality being about 2.3 NCO groups per molecule.

### Example 15

### Preparation of a Thermoplastic Polyurethane (TPU) Based on Polyether

750 g of a polytetrahydrofuran with an average molar mass of 1000 g/mol (PolyTHF® 1000, BASF AG) is heated to about 80° C. in a bucket made from tinplate. The additives from table 3 are then added, with stirring, as were 93 g of butanediol. The solution is heated to 75° C., with stirring. 450 g of diphenylmethane 4,4′-diisocyanate are then added, and the mixture is stirred until the solution is homogeneous. The TPU was then poured into a flat dish and heat-conditioned, first for 10 min at 125° C. on a hot plate, and then for 24 h at 100° C. in an oven. The sheets are cooled and then milled in a mill to give granulated material. 2% by weight of yellow color concentrate 138 (Elastogran GmbH) are then incorporated homogeneously into the granulated material by mixing, and the material is processed in an injection molding machine to give injection-molded sheets of thickness 2 mm. The Shore hardness of the product was 85 A.

table 3 gives information on the nature and amount of the stabilizers used. Irgano® and Tinuvin® are stabilizer trademarks of Ciba Specialty Chemicals GmbH, Germany.

TABLE 3
Stabilizer mixtures comprising inventive stabilizers
having HALS active ingredient groups

| | Stabilizer 1 | Stabilizer 2 | Stabilizer 3 | Stabilizer 4 |
|---|---|---|---|---|
| | (0.5% by | (0.5% by | (0.3% by | (0.25% by |
| Example | weight) | weight) | weight) | weight) |
| 15-a | Irganox 1010 | Irganox 1098 | Tinuvin 328 | Tinuvin 622 |
| 15-b | Irganox 1010 | Irganox 1098 | Tinuvin 328 | Stabilizer A |
| | | | | (table 1) |
| 15-c | Irganox 1010 | Irganox 1098 | Tinuvin 328 | Stabilizer B |
| | | | | (table 1) |
| 15-d | Irganox 1010 | Irganox 1098 | Tinuvin 328 | Stabilizer C |
| | | | | (table 1) |
| 15-e | Irganox 1010 | Irganox 1098 | Tinuvin 328 | Stabilizer D |
| | | | | (table 1) |

To determine UV resistance, the injection-molded sheets were irradiated with light to DIN 75202. The yellowness indices (YIs) of the irradiated specimens were then determined, using color measurement equipment from Hunterlab. table 4 gives the radiation results.

As is clearly seen, the specimens which comprise the inventive HALS stabilizers exhibit markedly less discoloration than the specimen using the comparative example (table 4).

TABLE 4
Yellowness indices after irradiation with light to DIN 75202

| Example | 0 h | 100 h | 300 h | 500 h |
|---|---|---|---|---|
| 15-a (comp.) | 94.6 | 95.1 | 99.8 | 102.6 |
| 15-b | 94.4 | 94.3 | 94.7 | 97.4 |
| 15-c | 94.9 | 95.3 | 95.5 | 96.4 |
| 15-d | 94.5 | 95.1 | 96.7 | 96.5 |
| 15-e | 94.9 | 95.3 | 96.4 | 96.4 |

### Example 16

### Stabilization of a TPU Using Inventive Stabilizer Comprising Phenolic Active Ingredient Groups in Comparison with Commercially Available Products

A test series comprising the stabilizers I and H from table 2 was prepared according to the specification in example 15. Once the cast skins had been granulated, the product was injection molded to give 2 mm test sheets without addition of the color concentrate.

Table 5 gives information on the nature and amount of stabilizers used. The comparative stabilizer comprises the phenolic stabilizer Ralox 35 (Raschig GmbH, Ludwigshafen). This stabilizer has a high concentration of active ingredient groups (3.4 mol/kg).

TABLE 5
Concentration of stabilizer in polyether TPU

| | Stabilizer H | Stabilizer I | Comparative stabilizer |
|---|---|---|---|
| Example | from table 2 | from table 2 | Ralox 35 |
| 16-a | 1.0% | | |
| 16-b | | 1.0% | |
| 16-c | 1.7% | | |
| 16-d | | 2.1% | |
| 16-e | | | 1.0% |

An important aim of stabilization of polyether TPU is an increase in resistance to thermooxidative degradation. One way of achieving this is addition of sterically hindered phenols. In order to measure and examine the effectiveness of the stabilizers used, S 2 specimens are stamped out from the injection molded sheets and aged in a convection oven at 130° C. The tensile strain at break to DIN 53504 is then determined. As can be seen in table 6, the action of the inventive stabilizers is superior to that of the commercially available product. In experiments 16a and 16b, the concentration of active ingredient groups is only 17% of the concentration in experiment 16e using the comparative stabilizer, but the tensile strain at break nevertheless remains at a high level for a longer time.

TABLE 6
Fall-off in tensile strain at break on storage of
specimens in a convection oven at 130° C.

| | Tensile | Tensile | Tensile | Tensile | Tensile | Tensile |
|---|---|---|---|---|---|---|
| | strain at | strain at | strain at | strain at | strain at | strain at |
| | break (%) | break (%) | break (%) | break (%) | break (%) | break (%) |
| Example | 0 days | 7 days | 14 days | 21 days | 28 days | 42 days |
| 16-a | 560 | 720 | 700 | 660 | 550 | 400 |
| 16-b | 540 | 760 | 720 | 710 | 620 | 470 |
| 16-c | 660 | 720 | 770 | 730 | 680 | 560 |
| 16-d | 580 | 690 | 730 | 730 | 760 | 640 |
| 16-e (comp.) | 470 | 640 | 460 | 370 | 300 | 220 |

### Example 17

### Stabilization of a Polyester

2 g of the specimen as constituted in table 7 are introduced into a laboratory mixing molder (LMM from Atlas Material Testing Solutions LLC, Chicago), and the product is melted at 260° C. for 1 min and then mixed for 3 min at this temperature by means of a ram rotating at 80 rpm. The polymer is then drawn to give a strand of diameter about 1.5 mm, from each end of which 0.25 g is cut away. The strand of polymer is then stored at 150° C. in a drying cabinet under normal atmospheric conditions. In each case, the solution viscosity (viscosity number VN in ml/g) of the polymer to DIN 53728 is determined after 10 days and after 20 days and compared with that of the specimen without heat conditioning, in order to assess molecular weight degradation.

The constitutions of the specimens and the results of the viscosity measurements are shown in tables 7 and 8. Irgano® and Irgaphos® are trade names of Ciba Specialty Chemicals GmbH, Germany, and Ultradur® B 4520 is a polybutylene terephthalate from BASF AG.

TABLE 7
Comparative experiments using prior-art
stabilizers, data in % by weight

| Example | 17-a | 17-b | 17-c | 17-d | 17-e | 17-f | 17-g |
|---|---|---|---|---|---|---|---|
| Ultradur ® B4520 | 99.3 | 99.2 | 99.3 | 99.4 | 99.5 | 99.4 | 100.0 |
| Irganox ® XP 620 | 0.7 | | | 0.3 | 0.2 | | |
| Irgafos ® 126 | | 0.8 | | 0.3 | | 0.3 | |
| Irganox ® 245 | | | 0.7 | | 0.3 | 0.3 | |
| VN - zero value | 126 | 127 | 125 | 126 | 127 | 127 | 125 |
| VN - 10 days | 121 | 126 | 126 | 125 | 125 | 121 | 109 |
| at 150° C. | | | | | | | |
| VN - 20 days | 120 | 120 | 124 | 123 | 120 | 119 | 109 |
| at 150° C. | | | | | | | |

TABLE 8
Inventive examples, data in % by weight

| Example | 17-h | 17-i | 17-j | 17-k | 17-l | 17-m | 17-n | 17-o |
|---|---|---|---|---|---|---|---|---|
| Ultradur ® | 99.5 | 99.5 | 99.5 | 99.3 | 99.1 | 99.1 | 99.4 | 99.4 |
| B4520 | | | | | | | | |
| Stabilizer A | 0.5 | | | | | | | |
| (tab. 1) | | | | | | | | |
| Stabilizer B | | 0.5 | | | | | | |
| (tab. 1) | | | | | | | | |
| Stabilizer C | | | 0.5 | | | | | |
| (tab. 1) | | | | | | | | |
| Stabilizer D | | | | 0.7 | | | | |
| (tab. 1) | | | | | | | | |
| Stabilizer F | | | | | 0.9 | | | |
| (tab. 2) | | | | | | | | |
| Stabilizer G | | | | | | 0.9 | | |
| (tab. 2) | | | | | | | | |
| Stabilizer H | | | | | | | 0.6 | |
| (tab. 2) | | | | | | | | |
| Stabilizer I | | | | | | | | 0.6 |
| (tab. 2) | | | | | | | | |
| VN - zero | 125 | 129 | 125 | 123 | 121 | 121 | 122 | 125 |
| value | | | | | | | | |
| VN - 10 days | 125 | 128 | 129 | 127 | 122 | 123 | 125 | 127 |
| at 150° C. | | | | | | | | |
| VN - 20 days | 137 | 135 | 135 | 138 | 132 | 129 | 128 | 134 |
| at 150° C. | | | | | | | | |

The results show that the viscosity number VN of the unstabilized polyester specimen falls away markedly on aging. In the case of the stabilized specimens in the comparative experiments (table 7), the VN likewise falls away, but to a lesser extent, whereas the VN values for the specimens stabilized according to the invention (table 8) actually increase after aging.

1: A stabilizer composed of
(I) one or more polyisocyanates having an average of from 2.2 to 10,
(II) per mole of isocyanate groups, from 0.1 to 1.0 mol of one or more active ingredient groups which protect plastics from degradation via heat, UV radiation, oxidation, hydrolysis, or mechanical action during processing, where the active ingredient groups have been linked to the polyisocyanates by way of functional groups A which can react with the isocyanate groups, and where the active ingredient groups have been selected from sterically hindered amines (HALS stabilizers), benzotriazoles, benzophenones, aromatic amines, or phosphites; and
(III) per mole of isocyanate groups, from 0 to 0.9 mol of one or more auxiliary groups which modify the properties of the stabilizer, where the auxiliary groups have been linked to the polyisocyanates by way of functional groups B which can react with the isocyanate groups,
the stabilizer having in essence no free NCO groups.

2: A stabilizer as claimed in claim 1, containing, as active ingredient groups (II), phosphites of the general formula (2) 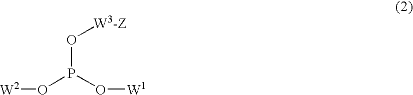
in bonded form;
where W¹, W², and W³ are, independently of one another, a straight-chain, branched or cyclic alkyl radical having from 1 to 30 carbon atoms, or a substituted or unsubstituted aryl radical having from 3 to 30 carbon atoms, and W² and W³ may also, independently of the other, be hydrogen, and Z is a radical of the formula
—C—R′-A
where R¹ is a single bond or a linear or branched divalent organic radical having from 1 to 100 carbon atoms, preferably from 1 to 12 carbon atoms, particularly preferably from 1 to 6 carbon atoms, or R¹ is a divalent radical of the formula
—(R²C¹—R³)ₘ—
where each of R² and R³ is identical with or different from the other and, independently of the other, is a single bond, a linear or branched divalent organic radical having from 1 to 50 carbon atoms, preferably from 1 to 10 carbon atoms, in particular from 1 to 4 carbon atoms and m is a number from 1 to 100, preferably from 1 to 10, and particularly preferably from 1 to 4
and each of C and C¹ is, independently of the other, a single bond, an oxygen atom, a sulfur atom, an —NH— or —NR— group, an ester group (—C(O)O— or —O(O)C—), an amide group (—NHC(O)— or —C(O)NH—), a urethane group (—OC(O)NH— or —HNC(O)O—), or a urea group (—HNC(O)N— or —NC(O)NH—).

3: A stabilizer as claimed in claim 1, containing, as active ingredient group (II), benzotriazoles of the general formula (3) 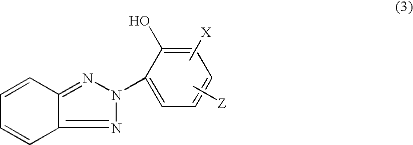
in bonded form,
where X is a straight-chain, branched, or cyclic alkyl radical having from 1 to 12 carbon atoms, and Z is a radical of the formula
—C—R¹-A
where R¹ is a single bond or a linear or branched divalent organic radical having from 1 to 100 carbon atoms, preferably from 1 to 12 carbon atoms, particularly preferably from 1 to 6 carbon atoms, or R¹ is a divalent radical of the formula
(R²C¹—R³)ₘ—
where each of R² and R³ is identical with or different from the other and, independently of the other, is a single bond, a linear or branched divalent organic radical having from 1 to 50 carbon atoms, preferably from 1 to 10 carbon atoms, in particular from 1 to 4 carbon atoms and m is a number from 1 to 100, preferably from 1 to 10, and particularly preferably from 1 to 4.
and each of C and C¹ is, independently of the other, a single bond, an oxygen atom, a sulfur atom, an —NH— or —NR— group, an ester group (—C(O)O— or —O(O)C—), an amide group (—NHC(O)— or —C(O)NH—), a urethane group (—OC(O)NH— or —HNC(O)O—), or a urea group (—HNC(O)N— or —NC(O)NH—).

4: A stabilizer as claimed in claim 1, containing, as active ingredient groups (II), benzophenone active ingredients of the general formula (4) 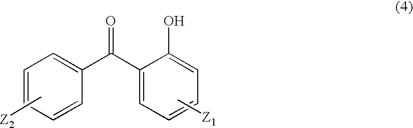
in bonded form,
where Z₁ and Z₂, independently of one another are Z or C—X, where X is a hydrogen atom, a straight-chain or branched alkyl radical, or a cycloalkyl radical having from 1 to 12 carbon atoms.

5: A stabilizer as claimed in claim 1, containing, as active ingredient groups (II) HALS active ingredients of the general formula (5) 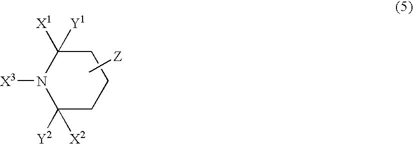
in bonded form,
where X¹, X², Y¹, Y² and X³ are, independently of one another, a hydrogen atom, a straight-chain or branched alkyl radical, or a cycloalkyl radical having from 1 to 12 carbon atoms, and X³ may moreover be an acyl radical having from 2 to 18 carbon atoms, an alkoxy radical having from 1 to 19 carbon atoms, or an aryloxycarbonyl radical having from 7 to 12 carbon atoms, and Z is a radical of the formula
—C—R¹-A
where R¹ is a single bond or a linear or branched divalent organic radical having from 1 to 100 carbon atoms, preferably from 1 to 12 carbon atoms, particularly preferably from 1 to 6 carbon atoms, or R¹ is a divalent radical of the formula
(R²C¹—R³)ₘ—
where each of R² and R³ is identical with or different from the other and, independently of the other, is a single bond, a linear or branched divalent organic radical having from 1 to 50 carbon atoms, preferably from 1 to 10 carbon atoms, in particular from 1 to 4 carbon atoms and m is a number from 1 to 100, preferably from 1 to 10, and particularly preferably from 1 to 4,
and each of C and C′ is, independently of the other, a single bond, an oxygen atom, a sulfur atom, an —NH— or —NR— group, an ester group (—C(O)O— or —O(O)C—), an amide group (—NHC(O)— or —C(O)NH—), a urethane group (—OC(O)NH— or —HNC(O)O—), or a urea group (—HNC(O)N— or —NC(O)NH—.

6: A stabilizer as claimed in claim 1, containing, as active ingredient group (II), aromatic amines of the general formula (6) 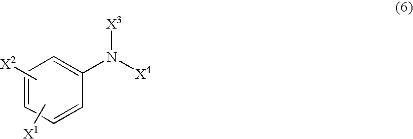
in bonded form,
where X¹, X², X³ and X⁴ are, independently of one another, a hydrogen atom, a straight-chain or branched alkyl radical, or a cycloalkyl radical having from 1 to 12 carbon atoms or Z, and
moreover X⁴ may be 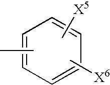
where X⁵ and X⁶ are, independently of one another, a hydrogen atom, a straight-chain or branched alkyl radical, or a cycloalkyl radical having from 1 to 12 carbon atoms, or Z, where Z is a radical of the formula
—C—R¹-A
where R¹ is a single bond or a linear or branched divalent organic radical having from 1 to 100 carbon atoms, preferably from 1 to 12 carbon atoms, particularly preferably from 1 to 6 carbon atoms, or R¹ is a divalent radical of the formula
—(R²C¹—R³)ₘ—
where each of R² and R³ is identical with or different from the other and, independently of the other, is a single bond, a linear or branched divalent organic radical having from 1 to 50 carbon atoms, preferably from 1 to 10 carbon atoms, in particular from 1 to 4 carbon atoms and m is a number from 1 to 100, preferably from 1 to 10, and particularly preferably from 1 to 4,
and each of C and C¹ is, independently of the other, a single bond, an oxygen atom, a sulfur atom, an —NH— or —NR— group, an ester group (—C(O)O— or —O(O)C—), an amide group (—NHC(O)— or —C(O)NH—), a urethane group (—OC(O)NH— or —HNC(O)O—), or a urea group (—HNC(O)N— or —NC(O)NH—).

7-10. (canceled)
